(19) United States
(12) Patent Application Publication
(10) Pub. No.: US 2009/0312172 A1
(43) Pub. Date: Dec. 17, 2009

(54) OPTICAL GLASS AND OPTICAL DEVICE

(75) Inventor: Kohei Nakata, Utsunomiya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/303,187

(22) PCT Filed: Jul. 31, 2007
(86) PCT No.: PCT/JP2007/065324

§ 371 Date: Dec. 2, 2008

(30) Foreign Application Priority Data
Aug. 1, 2006 (JP) 2006-209760
Jul. 10, 2007 (JP) 2007-181117

(51) Int. Cl. C03C 3/068

(52) U.S. Cl. 501/78

(57) ABSTRACT

An optical glass suitable for precision molding glass preform having a low glass transition temperature and optical characteristics such as a high refractive index and low dispersion is provided. The optical glass contains, as essential components, cationic components of Si⁴⁺, B³⁺, Zn²⁺, La³⁺, Ta⁵⁺, Ga³⁺, and W⁶⁺ and has a refractive index (nd) of 1.8-1.9 and an abbe number (νd) of 35-42, thus less causing striae and devitrification during fusion discharge.

### TECHNICAL FIELD

The present invention relates to an optical glass for forming a high-precision optical device for use in a lens or the like.

### BACKGROUND ART

In recent years, with an increase in amount of production of cameras including a digital camera, aspherical lens produced by precision molding has been used frequently. As a production process for producing an optical device such as the aspherical lens or the like at low cost, a process in which molten glass is added dropwise in a mold and formed by the mold. However, generally, when an optical glass is heated up to a temperature of 1000° C. or more to be melted, striae and devitrification are caused to occur in the molded optical device. For this reason, an optical glass having such an optical characteristic that the striae and the devitrification are minimized is required. Particularly, in order to improve an optical performance of a camera or the like, an optical glass which has a high refractive index and low (optical) dispersion and less causes striae and devitrification has been required.

Japanese Laid-Open Patent Application (JP-A) Sho 56-078447 has disclosed an optical glass which has a high refractive index and low dispersion and contains SiO₂, B₂O₃, La₂O₃, and Yb₂O₃ as essential components. JP-A Hei 08-217484 has disclosed an optical glass which has a high refractive index and low dispersion and contains B₂O₃, La₂O₃, Lu₂O₃, and RO (where R═Zn, Mg, Ca, Sr, Ba) as essential components. Further, JP-A 2002-012443 has disclosed, in Embodiment 10, an optical glass which has a high refractive index and low dispersion and contains SiO₂, B₂O₃, ZnO, La₂O₃, Ta₂O₅, Ga₂O₃, and WO₃.

However, the optical glass disclosed in JP-A SHo 56-078447 contains Yb₂O₃, and the optical glass disclosed in JP-A Hei 08-217484 contains Lu₂O₃. These components (Yb₂O₃ and Lu₂O₃) are very expensive, so that these components are ineffective as components for a general-purpose optical glass.

Further, the optical glass disclosed in JP-A 2002-012443 specifically contains La₂O₃ (32%) and Ta₂O₅ (4%). In this case, both of these components are capable of increasing a refractive index of the optical glass and decreasing dispersion of the optical glass. However, La₂O₃ is liable to volatilize in a high temperature state of the optical glass, so that striae are caused to occur when a melted glass heated up to 1000° C. or more is directly supplied into a mold.

### DISCLOSURE OF THE INVENTION

A principal object of the present invention is to provide an optical glass suitable for producing an optical device, by a melt (molding) process, having an optical characteristic including a high refractive index and low dispersion. A specific object of the present invention is to provide a high-precision optical glass which is inexpensive, causes less striae and devitrification, and has a high refractive index and low dispersion.

According to an aspect of the present invention, there is provided an optical glass comprising:

cationic components, as essential components, comprising Si⁴⁺ in an amount of 1% or more and 10% or less, B³⁺ in an amount of 20% or more and 50% or less, Zn²⁺ in an amount of 4% or more and 20% or less, La³⁺ in an amount of 15% or more and 20% or less, Ta⁵⁺ in an amount of 5% or more and 7% or less, Ga³⁺ in an amount of 0.5% or more and 10% or less, and W⁶⁺ in an amount of 0.5% or more and 10% or less, on a cationic % basis.

According to another aspect of the present invention, there is provided an optical glass comprising:

components, as essential components, comprising SiO₂ in an amount of 1 wt. % or more and 15 wt. % or less, B₂O₃ in an amount of 5 wt. % or more and 25 wt. % or less, ZnO in an amount of 3 wt. % or more and 30 wt. % or less, La₂O₃ in an amount of 20 wt. % or more and 36 wt. % or less, Ta₂O₅ in an amount of 10 wt. % or more and 17 wt. % or less, Ga₂O₃ in an amount of 0.1 wt. % or more and 10 wt. % or less, and WO₃ in an amount of 1 wt. % or more and 20 wt. % or less.

These and other objects, features and advantages of the present invention will become more apparent upon a consideration of the following description of the preferred embodiments of the present invention.

### BEST MODE FOR CARRYING OUT THE INVENTION

The optical glass according to the present invention is heated up to a temperature of 1000° C. or more and melted in a melting (fusion) furnace. The melted glass is added dropwise in a receiving mold through a nozzle formed at a lower portion of the melting furnace. The glass added dropwise in the mold is cooled to be formed in a glass preform or an optical device (lens). The glass preform is supplied between an upper mold and a lower mold and subjected to press molding to provide an optical device (lens).

As the reason why striae and devitrification are caused to occur with respect to optical glass, a high liquidus temperature has been known.

In the case where the optical glass is melted and thereafter is added dropwise in the receiving mold, when a temperature during the dropwise addition is lower than a liquidus temperature, portions of striae and devitrification are extremely increased. Further, when a temperature for melting the optical glass is increased up to 1200° C. or more, platinum or the like constituting the melting furnace migrates into the melted glass, thus leading to the striae and devitrification. Accordingly, the liquidus temperature may desirably be 1100° C. or less.

When the melting temperature is low, viscosity of the optical glass is lowered. In the case where the viscosity is excessively lowered, when the melted glass is added dropwise into the receiving mold, the melted glass cannot be held in the receiving mold. As a result, it is difficult to create a shape of a glass preform or an optical device. Also from this point, it is important that the liquidus temperature is kept low so as not to excessively increase the melting temperature.

Further, in the case where an optical device is produced by supplying a glass preform formed from a melted glass between upper and lower molds and press-molding the glass preform, it is effective that a glass transition temperature (Tg) is kept low. In the case of shaping the glass preform, the glass preform has to be once heated to a temperature of more than the glass transition temperature and then be press-molded. When the glass transition temperature is high, a pressing temperature is high, thus leading to a lowering in mold durability. Further, in order to press the glass preform at low temperature, it is necessary to increase a molding pressure. This largely affects not only an increase in cost due to replacement of the mold or the like but also profile irregularity. Accordingly, it is desirable that the glass transition temperature (Tg) is as low as possible, particularly in a range from 550° C. to 650° C. By effecting the press molding at a press-molding temperature of 600° C. or more and 800° C. or less, it is possible to provide a high-quality optical device with less striae and devitrification.

The optical glass of the present invention contains, as essential components, cationic components comprising Si⁴⁺, B³⁺, Zn²⁺, La³⁺, Ta⁵⁺, Ga³⁺ and W³⁺. These essential cationic components are consisting of Si⁴⁺ in an amount of 1% or more and 10% or less, B³⁺ in an amount of 20% or more and 50% or less, Zn²⁺ in an amount of 4% or more and 20% or less, La³⁺ in an amount of 15% or more and 20% or less, Ta⁵⁺ in an amount of 5% or more and 7% or less, Ga³⁺ in an amount of 0.5% or more and 10% or less, and W⁶⁺ in an amount of 0.5% or more and 10% or less, on a cationic % basis.

Herein, the cationic % of each of the cationic components means a ratio of the ion number of an associated cation to the sum of the ion numbers of all the cationic components (Si⁴⁺, B³⁺, Zn²⁺, La³⁺, Ta⁵⁺, Ga³⁺ and W³⁺) on a percentage (%) basis.

Si⁴⁺ functions as glass network-forming component and is effective in increasing viscosity of glass and improving anti-devitrification. When the cationic % of Si⁴⁺ less than 1%, a viscosity-increasing effect is insufficient. When the cationic % of Si⁴⁺ is more than 10%, the glass transition temperature and the melting temperature are high, so that molding precision of glass is lowered and a quality of lens is impaired. Si⁴⁺ can be incorporated into the optical glass by using SiO as a source material.

B³⁺ functions as glass network-forming component and is effective in improving a melting property of glass. Below 20%, a melting property improving effect is insufficient. Above 50%, the anti-devitrification is insufficient and a refractive index is lowered. B³⁺ can be incorporated into the optical glass by using B₂O₃ or H₃BO₃ as a source material.

Zn²⁺ is a component having a large effect of lowering the glass transition temperature without increasing the liquidus temperature. Further, Zn²⁺ has an effect of not only providing a high refractive index and low dispersion but also improving the anti-devitrification and lowering a viscous flow temperature during melting. Below 4%, the effects are insufficient. Above 20%, the anti-devitrification is insufficient and viscosity is also lowered. Zn²⁺ can be incorporated into the optical glass by using ZnO or ZnCO₃ as a source material.

La³⁺ is effective in increasing the refractive index of glass and lowering the dispersion. Below 15%, the refractive index is lowered and above 20%, the anti-devitrification. La³⁺ can be incorporated into the optical glass by using La₂O₃, lanthanum carbonate, lanthanum nitrate, or hydrates thereof as a source material.

Ta⁵⁺ is effective in increasing the refractive index of glass and lowering the dispersion. Below 5%, it is difficult to retain the high refractive index while keeping the low dispersion. Above 7%, the liquidus temperature is increased to lead to a lowering in anti-devitrification and viscosity, so that it is difficult to perform molding after melting discharge of glass. Ta⁵⁺ can be incorporated into the optical glass by using Ta₂O₅ as a source material.

Both of La³⁺ and Ta⁵⁺ are effective components for increasing the refractive index of glass and lowering the dispersion. However, when only La³⁺ or Ta⁵⁺ is used, the anti-devitrification or the viscosity is caused to be lowered. Accordingly, it is important that both of La³⁺ and Ta⁵⁺ are contained in a balanced manner.

Ga³⁺ is effective in increasing the refractive index of glass and lowering dispersion without increasing the liquidus temperature. Below 0.5%, an effect thereof is insufficient and above 10%, the liquidus temperature is increased. Ga³⁺ can be incorporated into the optical glass by using Ga₂O₃ as a source material.

W⁶⁺ is effective in increasing the refractive index of glass without increasing the liquidus temperature. Below 0.5%, an effect thereof is insufficient and above 10%, the anti-devitrification is lowered to decrease a transmittance in a visible region. W⁶⁺ can be incorporated into the optical glass by using WO₃ as a source material.

The optical glass according to the present invention may also contain, as optional components, cationic components including Gd³⁺, Ge⁴⁺, Nb⁵⁺, Zr⁴⁺, Li⁺, Na⁺, K⁺, and Sb³⁺. An amount of each of these optional cationic components is 10% or less for Gd³⁺, 10% or less for Ge⁴⁺, 10% or less for Nb⁵⁺, 10% or less for Zr⁴⁺, and 10% or less for Sb³⁺ on the cationic % basis. Further, an amount of Li⁺, Na⁺, and K⁺ is 10% or less in total on the cationic % basis.

Gd³⁺ is effective in not only increasing the refractive index of glass and lowering the dispersion but also improving the anti-devitrification. Above 10%, the anti-devitrification is lowered. Gd³⁺ can be incorporated into the optical glass by using Gd₂O₃ as a source material.

Ge⁴⁺ is effective in increasing the refractive index of glass and lowering the dispersion. Above 10%, the anti-devitrification is lowered. Ge⁴⁺ can be incorporated into the optical glass by using GeO₂ as a source material.

Nb⁵⁺ is effective in increasing the refractive index of glass and lowering the dispersion. Above 10%, the anti-devitrification is lowered. Nb⁵⁺ can be incorporated into the optical glass by using Nb₂O₅ as a source material.

Zr⁴⁺ is effective in increasing the refractive index of glass. Above 10%, the anti-devitrification is lowered. Zr⁴⁺ can be incorporated into the optical glass by using ZrO₂ as a source material.

Li⁺, Na⁺ and K⁺ are effective components for lowering the glass transition temperature. Particularly, Li⁺ has a large effect. However, a large amount in total of these components leads to considerable lowerings in anti-devitrification and refractive index, so that the total amount of Li⁺, Na⁺, and K⁺ is 10% or less on the cationic % basis. Li⁺, Na⁺, and K⁺ can be incorporated into the optical glass by using a carbonate or a nitrates as a source material.

Sb³⁺ can be added for fining or clarification during the melting of glass. Above 3%, a transmittance at a short wavelength of light in a visible region is lowered. Sb³⁺ can be incorporated into the optical glass by using Sb₂O₃ as a source material.

The above described source materials used for incorporating the respective components into the optical glass are not limited to those specifically described above. Accordingly, depending on a condition for glass production, the source materials can be selected from known materials for Al³⁺ or Ba²⁺.

As a component for the optical glass, As³⁺ (arsenic compound) which is a component considerably increasing an environmental load cannot be used. Further, for a general-purpose optical device (lens), the use of an expensive material (cationic component) such as Yb³⁺ or Lu³⁺ is not practical from the viewpoint of cost reduction.

### Experimental Embodiments

Optical devices were produced by using source materials for glass in Embodiment 1 to Embodiment 8 and Comparative Embodiment 1 to Comparative Embodiment 3 shown in Table 1. For production, first, glass source materials in each Embodiment were weighed, mixed and melted in a plutinum crucible for 5 hours at temperatures from 1100° C. to 1300° C. After the melting, the melted material was fined (clarified) and stirred to be uniformized and then was added dropwise in a receiving mold through a plutinum pipe heated at 1100° C. The glass added dropwise in the receiving mold was cooled to obtain a glass preform. The glass preform was supplied between an upper mold and a lower mold and heated at 700° C., thus being subjected to press molding. The glass preform was cooled to prepare an optical device (lens).

Respective cationic components of the thus obtained optical glasses produced from the respective glass source materials shown in Table 1 are shown in Table 2 on a cationic % basis.

TABLE 1
(glass composition: weight %)

| | B₂O_{₃} | Ga₂O_{₃} | GeO₂ | Gd₂O_{₃} | La₂O_{₃} | Li₂O | Nb₂O_{₅} | Sb₂O_{₃} | WO₃ | SiO₂ | Ta₂O_{₅} | ZnO | ZrO₂ |
|---|---|---|---|---|---|---|---|---|---|---|---|---|---|
| EMB. 1 | 14.7 | 5.8 | | 6.6 | 35.8 | 1.0 | 1.9 | 0.1 | 1.5 | 5.3 | 16.6 | 5.3 | 5.4 |
| EMB. 2 | 17.6 | 6.1 | | 7.1 | 31.8 | 0.4 | | 0.1 | 4.5 | 3.5 | 14.3 | 10.6 | 4.0 |
| EMB. 3 | 15.0 | 3.0 | | 11.5 | 31.8 | | | | 2.9 | 2.9 | 14.0 | 15.0 | 3.9 |
| EMB. 4 | 14.5 | 3.0 | | 9.5 | 31.8 | | | | 4.9 | 3.4 | 14.0 | 15.0 | 3.9 |
| EMB. 5 | 15.0 | 3.0 | 4.0 | 6.5 | 29.8 | | | | 6.9 | 2.9 | 14.0 | 14.0 | 3.9 |
| EMB. 6 | 14.5 | 3.0 | 4.0 | 9.5 | 29.8 | | | | 4.9 | 3.4 | 14.0 | 14.0 | 3.9 |
| EMB. 7 | 12.4 | 1.8 | | 9.7 | 29.0 | | | 0.1 | 14.6 | 2.5 | 12.7 | 13.7 | 3.5 |
| EMB. 8 | 12.4 | 1.8 | | 7.7 | 29.0 | | | 0.1 | 16.6 | 2.5 | 12.7 | 13.7 | 3.5 |
| COMP. EMB. 1 | 15.3 | | | 7.0 | 45.0 | 1.0 | 2.0 | 0.2 | 1.6 | 5.5 | 17.2 | | 5.6 |
| COMP. EMB. 2 | 15.3 | | | 7.0 | 39.2 | 1.0 | 1.9 | 0.2 | 1.8 | 5.5 | 17.2 | 5.5 | 5.6 |
| COMP. EMB. 3 | 15.3 | 1.8 | | 7.0 | 29.0 | | 1.9 | 0.2 | 1.8 | 5.5 | 25.6 | 5.5 | 5.6 |

TABLE 2
(glass composition: cation %)

| | B³⁺ | Ga³⁺ | Ge⁴⁺ | Gd³⁺ | La³⁺ | Li⁺ | Nb⁵⁺ | Sb³⁺ | W⁶⁺ | Si⁴⁺ | Ta⁵⁺ | Zn²⁺ | Zr⁴⁺ |
|---|---|---|---|---|---|---|---|---|---|---|---|---|---|
| EMB. 1 | 38.4 | 5.6 | 0.0 | 3.3 | 20.0 | 6.1 | 1.3 | 0.1 | 0.6 | 8.0 | 6.8 | 5.9 | 4.0 |
| EMB. 2 | 44.4 | 5.7 | 0.0 | 3.4 | 17.2 | 2.4 | 0.0 | 0.1 | 1.7 | 5.1 | 5.7 | 11.5 | 2.9 |
| EMB. 3 | 40.6 | 3.0 | 0.0 | 6.0 | 18.4 | 0.0 | 0.0 | 0.0 | 1.2 | 4.5 | 6.0 | 17.4 | 3.0 |
| EMB. 4 | 39.5 | 3.0 | 0.0 | 5.0 | 18.5 | 0.0 | 0.0 | 0.0 | 2.0 | 5.4 | 6.0 | 17.5 | 3.0 |
| EMB. 5 | 40.5 | 3.0 | 3.6 | 3.4 | 17.2 | 0.0 | 0.0 | 0.0 | 2.8 | 4.5 | 5.9 | 16.2 | 3.0 |
| EMB. 6 | 39.0 | 3.0 | 3.6 | 4.9 | 17.1 | 0.0 | 0.0 | 0.0 | 2.0 | 5.3 | 5.9 | 16.1 | 3.0 |
| EMB. 7 | 36.9 | 2.0 | 0.0 | 5.5 | 18.4 | 0.0 | 0.0 | 0.1 | 6.5 | 4.3 | 5.9 | 17.4 | 2.9 |
| EMB. 8 | 36.9 | 2.0 | 0.0 | 4.4 | 18.5 | 0.0 | 0.0 | 0.1 | 7.4 | 4.3 | 6.0 | 17.5 | 2.9 |
| COMP. EMB. 1 | 41.6 | 0.0 | 0.0 | 3.7 | 26.2 | 6.1 | 1.4 | 0.1 | 0.7 | 8.7 | 7.4 | 0.0 | 3.8 |
| COMP. EMB. 2 | 40.3 | 0.0 | 0.0 | 3.5 | 22.1 | 6.1 | 1.3 | 0.1 | 0.6 | 8.4 | 7.1 | 6.2 | 4.2 |
| COMP. EMB. 3 | 40.3 | 2.0 | 0.0 | 3.8 | 17.8 | 0.0 | 1.5 | 0.1 | 0.8 | 8.9 | 11.3 | 6.6 | 4.2 |

The above produced optical glasses through the molding from the glass source materials of Embodiments 1-8 and Comparative Embodiments 1-3 were subjected to measurement of a refractive index (nd) and Abbe number (νd) after each glass was cooled. Further, a glass transition temperature (Tg) was measured by a mechanical thermal analysis equipment according to Japanese Optical glass Industrial Standards (JOGIS) 08-2003 (measuring method of thermal expansion coefficient of optical glass). A liquidus temperature (LT) was determined by placing each glass sample in a plurality of platinum crucibles, holding the crucibles for 2 hours under different temperature conditions, cooling the crucibles, and observing an inner portion of each glass sample through a microscope to check the presence or absence of crystal.

The results are shown in Table 3.

TABLE 3

| | nd | νd | Tg | LT | Result |
|---|---|---|---|---|---|
| EMB. 1 | 1.843 | 40.7 | 602 | 1050 | Good |
| EMB. 2 | 1.822 | 41.5 | 600 | 1050 | Good |
| EMB. 3 | 1.855 | 40.3 | 625 | 1030 | Good |
| EMB. 4 | 1.852 | 40.1 | 620 | 1030 | Good |
| EMB. 5 | 1.849 | 40.1 | 620 | 1070 | Good |
| EMB. 6 | 1.862 | 40.1 | 650 | 1080 | Good |
| EMB. 7 | 1.881 | 36.3 | 640 | 1000 | Good |
| EMB. 8 | 1.883 | 36.0 | 640 | 1000 | Good |
| COMP. EMB. 1 | — | — | — | — | Much devitrification occurred. *1 |
| COMP. EMB. 2 | 1.854 | 40.3 | 615 | 1120 | Striae/devitrification occurred. |
| COMP. EMB. 3 | 1.853 | 40.7 | 640 | 1150 | Striae/devitrification *2 |

*1: Much devitrification occurred during melting and thus molding was not performed.
*2: Striae and devitrification occurred(preform was not formable due to viscosity lowering, so that measurement was performed in bulk state).

As understood from Table 3, the optical glasses of Embodiments 1-8 and Comparative Embodiments 2 and 3 have such a characteristic that they have a high refractive index (nd) of 1.8 or more and 1.9 or less and Abbe number (νd) of 35 or more and 42 or less. This is because the cationic components La³⁺ and Ta⁵⁺ are ensured by mixing La₂O₃ and Ta₂O₅ in predetermined amounts as the glass source materials.

The optical glasses of Embodiments 1 to 8 have the liquidus temperatures of 1100° C. or less and the glass preforms therefor have no problem in terms of striae and devitrification. Further, viscosities of the optical glasses of Embodiments 1 to 8 during the dropwise addition were enough to mold the glass preforms. The glass source materials for the optical glasses of Embodiments 1 to 8 contain La₂O₃ in amounts of 20 wt. % or more and 36 wt. % or less and Ta₂O₅ in amounts of 10 wt. % or more and 17 wt. % or less. In these cases, the cation components for the optical glasses contain La³⁺ in amounts of 15% or more and 20% or less and Ta⁵⁺ in amounts of 5% or more and 7% or less, on the cationic % basis.

The optical glass of Comparative Embodiment 1 caused much devitrification at the time of the melting, thus being unsuitable as a lens without performing the molding. This may be attributable to a large amount of La₂O₅ of 45.0 wt. % as the glass source material, thus leading to a large amount of the cationic component La³⁺ for the optical glass of 26.2% (cationic %). In other words, the amount of the cationic component is excessively large, so that the liquidus temperature is presumably much higher than the temperature of the dropwise addition.

The optical glass of Comparative Embodiment 2 has the liquidus temperature of 1120° C. higher than the dropwise addition temperature of 1100° C., so that the optical glass causes such striae and devitrification and thus cannot be used as an optical device (lens). This may be attributable to large amounts of La₂O₃ of 39.2 wt. % and Ta₂O₅ of 17.2 wt. % as the glass source materials, thus leading to large amounts of the optical glass cationic components La³⁺ of 22.1% (cationic %) and Ta⁵⁺ of 7.1% (cationic %).

The optical glass of Comparative Embodiment 3 had a low viscosity at the dropwise addition temperature, so that the glass preform was unable to be produced by receiving the melted glass added dropwise in the receiving mold. For this reason, the measurements in Table 3 were performed in a bulk state. The glass source materials for the optical glass of Comparative Embodiment 3 contain a large amount of Ta₂O₅ of 25.6 wt. %, thus leading to a large amount of the optical glass cationic component Ta⁵⁺ of 9.1% (cationic %). As a result, the viscosity of the melted glass at the dropwise addition temperature was low, so that the glass preform was unable to be molded. In the bulk state, the optical glass of Comparative Embodiment 3 had the liquidus temperature of 1150° C. higher than the dropwise addition temperature of 1100° C., so that the optical glass caused much striae and devitrification. Also from this result, the optical glass for Comparative Embodiment 3 cannot be used as the optical device (lens).

### INDUSTRIAL APPLICABILITY

As described hereinabove, according to the present invention, it is possible to provide an optical glass suitable for producing, through melting molding, an optical device having an optical characteristic such that the optical device has a high refractive index and low (optical) dispersion. More specifically, it is possible to inexpensively provide a high-precision optical glass having a high refractive index and low dispersion with less occurrences of striae and devitrification.

1. An optical glass comprising:
cationic components, as essential components, comprising Si⁴⁺ in an amount of 1% or more and 10% or less, B³⁺ in an amount of 20% or more and 50% or less, Zn²⁺ in an amount of 4% or more and 20% or less, La³⁺ in an amount of 15% or more and 20% or less, Ta⁵⁺ in an amount of 5% or more and 7% or less, Ga³⁺ in an amount of 0.5% or more and 10% or less, and W⁶⁺ in an amount of 0.5% or more and 10% or less, on a cationic % basis.

2. A glass according to claim 1, wherein said optical glass has a refractive index (nd) of 1.8 or more and 1.9 or less and an abbe number (νd) of 35 or more and 42 or less.

3. A glass according to claim 1, wherein said optical glass has a liquidus temperature of 1000° C. or more and 1100° C. or less.

4. An optical device comprising:
a press-molded product prepared by press molding a glass preform formed of an optical glass according to claim 1 at a temperature of 600° C. or more and 800° C. or less.

5. An optical glass comprising:
components, as essential components,
comprising SiO₂ in an amount of 1 wt. % or more and 15 wt. % or less, B₂O₃ in an amount of 5 wt. % or more and 25 wt. % or less, ZnO in an amount of 3 wt. % or more and 30 wt. % or less, La₂O₃ in an amount of 20 wt. % or more and 36 wt. % or less, Ta₂O₅ in an amount of 10 wt. % or more and 17 wt. % or less, Ga₂O₃ in an amount of 0.1 wt. % or more and 10 wt. % or less, and WO₃ in an amount of 1 wt. % or more and 20 wt. % or less.
